(19) United States
(12) Patent Application Publication
(10) Pub. No.: US 2014/0325156 A1
(43) Pub. Date: Oct. 30, 2014

(54) Long Latency Tolerant Decoupled Memory Hierarchy for Simpler and Energy Efficient Designs

(71) Applicant: The Regents of the University of California, Oakland, CA (US)

(72) Inventor: Jose Renau Ardevol, Santa Cruz, CA (US)

(21) Appl. No.: 14/366,487

(22) PCT Filed: Dec. 17, 2012
(86) PCT No.: PCT/US12/70046

§ 371 Date: Jun. 18, 2014

Related U.S. Application Data
(60) Provisional application No. 61/630,788, filed on Dec. 19, 2011.

(51) Int. Cl. G06F 12/14; G06F 12/08

(52) U.S. Cl. CPC G06F 12/1416; G06F 12/0806
USPC 711/122; 711/154

(57) ABSTRACT

A decoupled memory execution verification method is provided that includes executing load and store commands separately using an appropriately programmed computer, where the load and store commands are independent of correctness, where the load commands and the store commands are re-executed in-order at memory retirement to verify correctness, where an energy efficient power decoupled execution of memory (e-PDEMI) is provided.

### FIELD OF THE INVENTION

The present invention relates generally to computer memory hierarchy. More particularly, the invention relates to a memory hierarchy that decouples memory operations into critical and non-critical operations to tolerate larger latency memory operations.

### BACKGROUND OF THE INVENTION

Many resources in modern out-of-order multiprocessors are dedicated to the execution of memory instructions. Memory instructions pose a challenge to this paradigm due to their ordering requirements. Particularly, slow load operations can slow down a processor. Memory speculation is a common technique used in out-of-order processors to overcome those hazards, however significant complexity and energy consumption is added to processors to support memory speculation. Memory speculation also affects the multiprocessor introducing more complex consistency models.

Because slow memory operations significantly affect overall system performance, architects invest area and additional complexity to support low latency memory operations in high performance processors, and to execute load operations as early as possible. Often though, these efforts sacrifice Sequential Consistency, which is the most intuitive shared-memory programming model. This is because supporting more relaxed consistency models (e.g., Release Consistency) usually allows for further optimizations and extraction of instruction level parallelism.

On the other hand, techniques to improve the performance of memory execution such as memory speculation or using fully associative load and store queues (LSQ), often result in higher energy consumption. Because of their fully associative structures, the LQ and SQ present significant scaling challenges due to the latency increases that would result from adding more entries. As a result, several researchers have proposed different mechanisms that replace the LSQ for non-fully-associative structures. With tighter power budgets due to shrinking technology size and increased amount of integration in the same area, the LSQ has become an issue for energy consumption as well. FIG. 1 shows the breakdown of dynamic energy consumption per instruction (EPI) for a typical 4-way out-of-order core, similar to Intel's Sandy Bridge, running several SPEC 2006 applications.

As it is shown, the main part of the energy consumption is dedicated to enhanced execution of memory operations. Both the LSQ and L1 data cache are main sources of energy consumption with over 27% and 13% respectively, but the Translation Lookaside Buffer (TLB) and the StoreSets are also not negligible with 4% of the total energy consumption each.

Different approaches are proposed to providing a scalable memory disambiguation scheme. In one attempt, Store Queue Index Prediction (SQIP) were proposed to replace the fully associative Store Queue by indexing it with a predicted index for each load searching for a data forward. The proposed mechanism uses a Store Set like PC-indexed table and a predictor based on the Exclusive Collision Predictor to avoid store-to-load data forward mispredictions. This work was extended in NoSQ by using Speculative Memory Bypassing. NoSQ added an additional register file read port to support data forwarding, and a Bloom filter accessed by every load.

In another attempt, Fire and Forget follows SQIP and NoSQ by removing the store queue completely. The ROB is relied upon to keep stores in program order, and to hold store results. Three prediction tables are added to speculatively forward a store's data to exactly one load in the load queue. Loads need re-execution at commit time against the data cache which is updated in order.

Program correctness depends on in-order back-end execution whereby the speculative data consumed by load instructions is checked against data obtained in the re-execution path that is guaranteed to be correct. A fully associative fuzzy disambiguation queue was proposed to reject loads from executing to the L0 cache if there are any older in-flight stores with matching address that have not yet executed. Additionally an age ordered memory operation sequencing queue is proposed to keep the address and data for speculatively executed loads, and the address and data for stores waiting to be executed in order in the back-end execution. SMDE does not consider energy efficiency in their proposal.

What is needed is an energy efficient memory execution verification method that decouples memory execution that integrates to a multicore system or memory hierarchy, memory coherence, or memory consistency.

### SUMMARY OF THE INVENTION

To address the needs in the art, a decoupled memory execution verification method is provided that includes executing load and store commands separately using an appropriately programmed computer, where the load and store commands are independent of correctness, where the load commands and the store commands are re-executed in-order at memory retirement to verify correctness, where an energy efficient power decoupled execution of memory (e-PDEMI) is provided.

According to one aspect of the invention, memory operations are decoupled into critical and non-critical operations, where the critical operations comprise a relatively low memory latency, where the critical operation does not have a correctness requirement, where the non-critical requirement comprises a relatively high memory latency, where the non-critical operation has a correctness requirement.

In another aspect of the invention, a virtual predictive cache (VPC) replaces an L1 data cache and a L0 data cache, where the VPC comprises a virtually indexed and virtually checked cache structure. Here, the VPC guarantees forward progress of any incorrect memory content, where the guaranteed correct memory contents are received at the memory retirement, where the memory retirement is disposed in an insensitive portion of a critical memory path, where a shared address mapped cache hierarchy is provided.

In a further aspect of the invention, each e-PDEMI includes an e-PDEMI core, where the e-PDEMI core provides a sequential consistency memory model in a multi-core configuration.

According to another aspect of the invention, the in-order verification eliminates memory ordering instructions, removes a coherence network from a memory hierarchy, eliminates store sets, and removes load store queues.

In another aspect of the invention, all speculative data are stored in a direct mapped memory buffer, where memory replays are mitigated using a serialization mechanism, where a sequential consistency is implemented without a requirement of rolling back a cache hierarchy state.

In yet another aspect of the invention the store instructions include an in-order memory issuance, an out-of-order address calculation, a write to a Value Prediction Cache (VPC), an in-order memory retirement in a re-order buffer (ROB), in-order writing of data to an L2 filter, or updating said VPC.

### BRIEF DESCRIPTION OF THE DRAWINGS

FIG. 1 shows L1 data cache and LSQ, represent 40% of the energy per instruction for a typical 4-way core.

FIGS. 2a-2b show a baseline architecture and an e-PDEMI architecture, according to one embodiment of the invention.

FIGS. 3a-3b show e-PDEMI Flowcharts for Load and Store Instructions, according to one embodiment of the invention.

FIGS. 4a-4b show single-core and multi-core benchmarks, where e-PDEMI has approximately the same performance as the baseline architecture, according to one embodiment of the invention.

FIG. 5 shows Private Cache Coherence doesn't improve e-PDEMI, but is critical for the Baseline, according to one embodiment of the invention.

FIGS. 6a-6b show single-core and multi-core results, where e-PDEMI has less than 3.5% for single-core and 2% for multi-core configurations increase in instructions executed on average as a result of memory replays, according to one embodiment of the invention.

FIG. 7 shows Stall characterization on Baseline and e-PDEMI architectures, according to one embodiment of the invention.

FIGS. 8a-8b show Single-core e-PDEMI has over 16% Average Energy per Instruction Savings, and Quad-core e-PDEMI has 10% Average Energy Savings, where e-PDEMI has better energy efficiency for all benchmarks, according to one embodiment of the invention.

FIG. 9 shows a comparison of e-PDEMI and SMDE Memory Hierarchy Energy Consumption, according to one embodiment of the invention.

FIG. 10 shows a comparison of e-PDEMI, SMDE, and Baseline Memory Hierarchy Area, according to one embodiment of the invention.

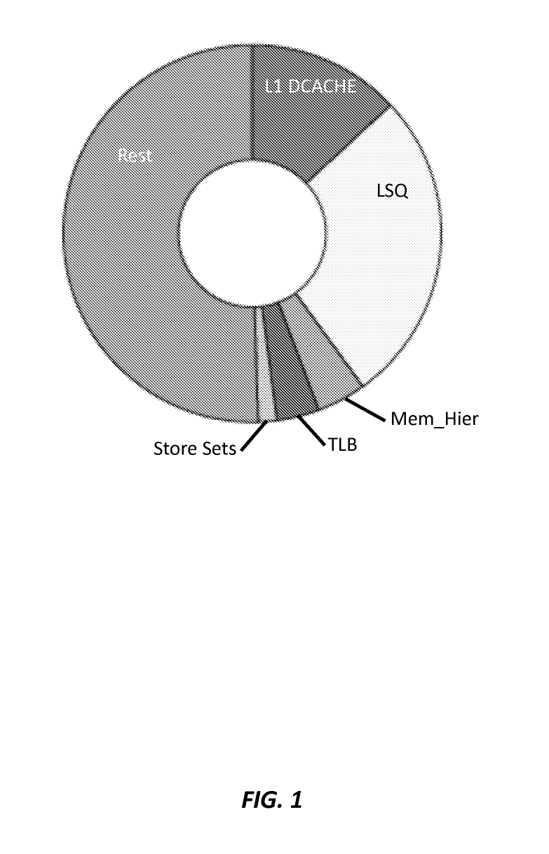

### DETAILED DESCRIPTION

The current invention provides a decoupled memory execution verification mechanism that supports memory speculation without costly and scaling limited structures. This in-order verification reduces the average energy dissipation by over 16% with a new design that removes the load and store queues, store sets, and even invalidation based cache coherence. All this while the system implements sequential memory consistency.

According to one embodiment of the current invention, an architecture is provided that focuses on design aspects that are usually contradictory in other designs: performance, energy, complexity, and sequential consistency. The current invention reduces complexity without complex LSQs, without store sets, and even without invalidation based cache coherence. According to one aspect the invention provides a decoupled memory execution verification like the L0 Cache. In a decoupled memory operation, loads and stores execute speculatively, independently of correctness. They are then re-executed in-order at retirement to verify correctness.

The current invention provides an energy efficient memory speculation mechanism removing critical structures from the critical path, providing an opportunity to optimize these structures for energy efficiency. The architecture according to one embodiment performs decoupled memory execution, and it does not implement a LSQ or Store-Sets. In one aspect, the TLB is removed from the speculative execution path and is accessed only at retirement. As a result, a virtually indexed and virtually checked cache-like structure is provided that is called Virtual Predictive Cache (VPC) instead of the L1 data cache.

The current architecture using the VPC is called an Efficient Power Decoupled Execution of Memory Instructions architecture, abbreviated e-PDEMI. The move of memory verification off the critical path allows tolerance of additional memory hierarchy latency in a single e-PDEMI core. The speculative VPC access is on the critical path, but it can be seen as a predictor where any incorrect result still guarantees forward progress. The guaranteed correct memory contents are received at retirement, which is a less sensitive part of the critical path as shown and discussed below.

This latency tolerance capability allows the removal of invalidation based cache coherence with the replacement of a shared address mapped cache hierarchy. The multi-core e-PDEMI system's memory hierarchy is implemented as a single, large shared, address-mapped, banked memory hierarchy system. In such a system, there is only ever one copy of a given cache line. Thus, memory coherence is not needed by the e-PDEMI system and is removed. The current invention works with traditional cache coherence, but evaluation shows a negligible performance impact, which does not seem to justify the additional associated complexity.

All memory operations are verified in-order at retirement. This, in addition to the address mapped shared cache hierarchy effectively means that each e-PDEMI core has a sequential consistency memory model in the multicore configuration. Notice that the in-order verification also allows further simplifications like the elimination of all memory ordering instructions (e.g., Memfence, MemBarrier, etc.).

For a 4-way out-of-order single-core, 16.4% average energy per instruction savings is achieved while improving the performance by up to 6.4% with an average of 3.4%. In a quad-core system composed of the same out-of-order cores, a 10% average total energy savings is achieved while improving performance up to 14% in programs with heavy lock usage with average performance equivalent to the baseline architecture.

The main distinguishing feature of e-PDEMI is that it redesigns the memory subsystem with energy efficiency as the first design parameter, yielding a multi-core with reduced coherence complexity and sequential memory consistency.

The e-PDEMI architecture of the current invention completely removes both the Load and the Store queues, adds no additional logic to the ROB, and does not add ports or additional contention to the register file. A different approach is to remove the Load Store Queue altogether and replace it with a speculatively updated and accessed cache.

The current invention removes the L1 and L0 caches, replaces them with a virtually indexed and checked predictor cache, removes the fully associative fuzzy disambiguation queue, and implements a simple mechanism to avoid excessive replays.

According to one embodiment of the e-PDEMI invention, all the speculative data are stored in a small direct mapped memory speculation buffer, replays are mitigated using a simple serialization mechanism, and sequential consistency is supported without the requirement of rolling back cache hierarchy state.

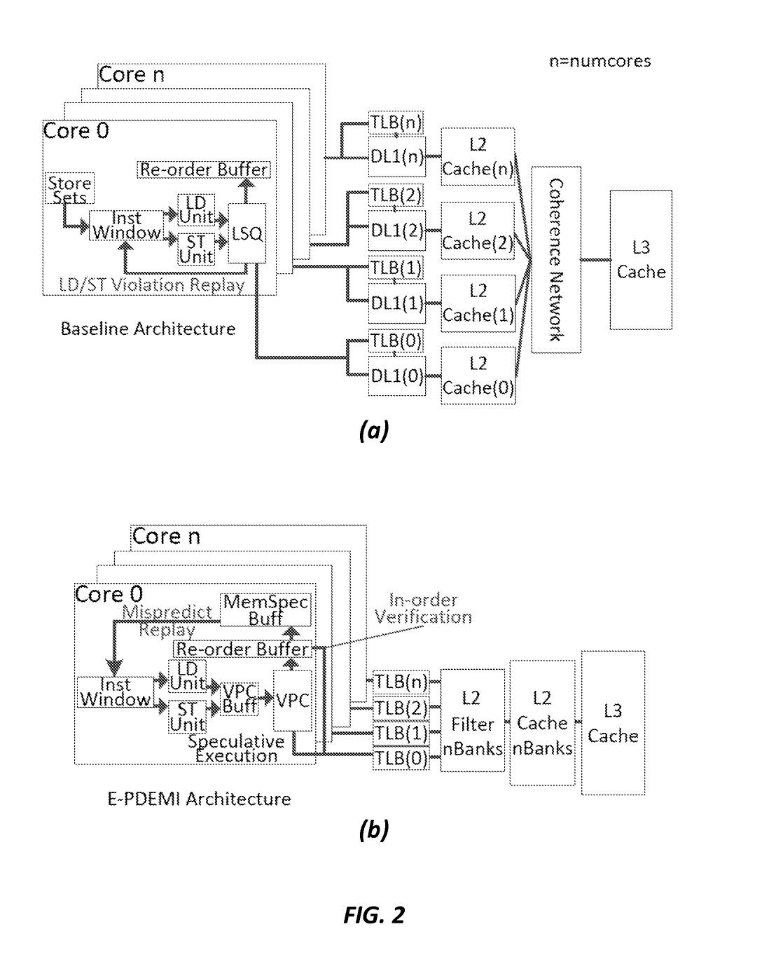

FIG. 2a shows a baseline architecture. Each baseline processor core is an out-of-order processor with an instruction window that can dispatch one load and one store instruction per cycle to dedicated load and store units. The load and store units can then each execute one instruction per cycle by accessing the traditional Load Store Queue. The Load Store Queue orders store instructions to be committed to the memory hierarchy in order, performs appropriate store-load forwarding and detects memory order violations resulting in replays. The Load Store Queue also supports forwarding of unaligned store data to consumer load instructions. A baseline system according to one embodiment of the current invention uses StoreSets to avoid replay loops resulting in slow forward progress. The StoreSets implementation requires the addition of a Store Set ID table to hash load and store instruction PCs to StoreSet IDs, and a Last Fetched Instruction table that tracks the last fetched memory instruction in a given store set to ensure serialization of memory instructions that cause replays. Additionally the Load Store Queue can issue one load and one store per cycle to the L1 data cache and TLB. The L1 data cache is virtually indexed and physically checked, meaning that the TLB is accessed in parallel with the tag bank and the successive data bank access is serialized. Table 1 lists the sizes and other relevant parameters for each of these structures.

The multicore baseline implementation is composed of multiple instances of the baseline core discussed above, each with a private L1 and L2 data cache. In order to maintain coherence across all private L1 and L2 data caches in the baseline system, each private L2 data cache is connected to a coherence network which implements the MOESI coherence protocol. Shown in FIG. 2a, each baseline core has a private TLB that is accessed in parallel with the L1 data cache. This is a performance increase supported by configuring the private L1 data caches to be virtually indexed and physically checked.

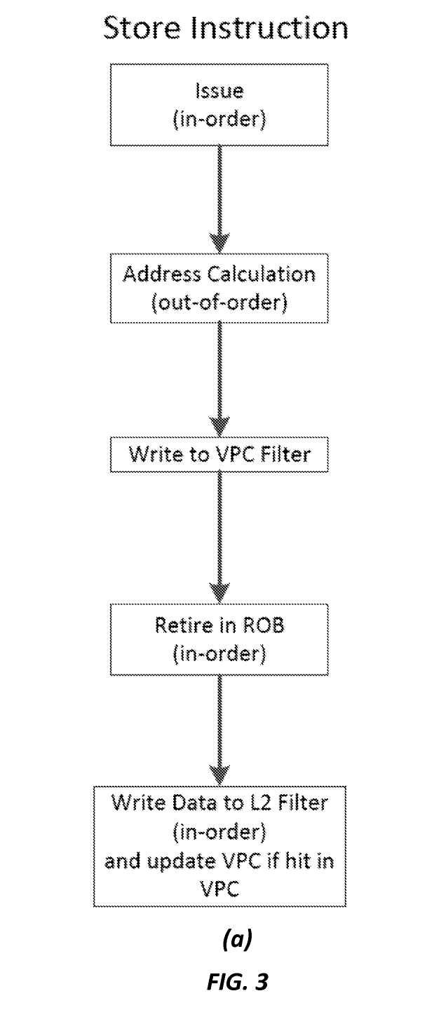

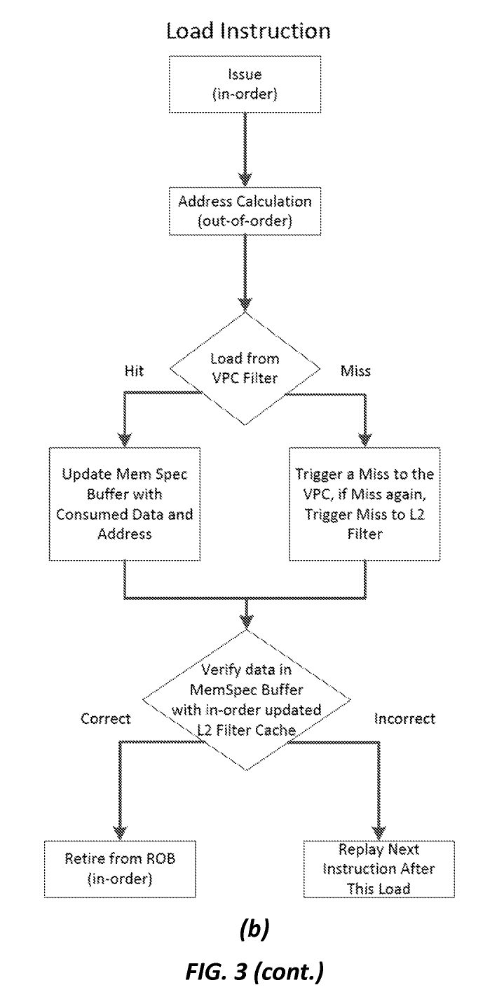

FIG. 2b illustrates the architecture according to a preferred embodiment of the invention, and FIG. 3 shows the pipeline flow of store and load instructions in the e-PDEMI architecture. The current embodiment targets an architecture that can reduce system power by completely removing the Load Store Queue, StoreSets, coherence interconnect and support mechanisms.

According to one embodiment, the current invention includes a virtually indexed and virtually checked VPC, which avoids the access time of the TLB. Memory instructions are allowed to issue directly to the VPC out-of-order without any intermediary memory disambiguation, forwarding prediction, or other support logic. Stores are dispatched from the Store unit out-of-order and speculatively update a decoupled VPC Buffer. The VPC buffer does not ever displace data into the VPC. Loads are dispatched from the Load Unit out of order to the VPC buffer first. If the VPC buffer hits on the load's address, the load speculatively consumes the data contained in the VPC buffer. The VPC buffer is able to forward unaligned store data to consumer load instructions. If the VPC buffer misses on the load's address, the load then accesses the VPC. If the VPC hits on the load's address, the load speculatively consumes the data contained in the VPC. If the VPC misses on the load's address, it triggers a miss request to the L2 Filter cache and obtains the requested data. It is important to note that the VPC replaces the L1 data cache and as shown below is the same size as the L1 data cache in the baseline architecture. The only additional structures added are the small filter cache in front of the L2 cache and the small memory speculation buffer storing inflight memory instructions' addresses and data for off critical path verification.

The L2 Filter Cache is implemented with a phase cache to provide energy savings by alleviating the L2 cache of additional re-execution accesses. It is important to note that the VPC never displaces speculative data to the L2 filter cache. Further, the data in the L2 filter cache is always correct. The correctness of the L2 filter cache and verification of the speculative data consumed by loads are both handled off of the critical path. At retirement, stores are issued in-order from the re-order buffer and update a small filter cache placed before the larger L2 cache. This is to avoid accessing the large L2 structure for every store. The store also updates the VPC. To avoid increasing register file pressure, or adding register file ports, a small memory speculation buffer is included that stores the data and address of each speculatively executed memory instruction. The memory speculation buffer is indexed by memory instructions' addresses.

Because store instructions are issued in order to the L2 cache through the filter cache, the content of the L2 cache is always correct. Additionally, because store instructions update the VPC in order at retirement the VPC is considered mostly correct. To reduce the energy cost of re-executing store instructions to the memory hierarchy, write-miss requests are not allowed to be sent from the VPC to the filter cache. Therefore, when a store instruction is issued to the VPC at retirement, if the associated cache line is not present in the VPC, the request is dropped and no further action is taken. Because the VPC is merely used to predict values, it is not necessary for the store to write its data into the VPC. If a consumer load executes speculatively some time after the store such that the VPC filter no longer contains the store's data, then the VPC will trigger a miss request to the L2 filter cache and the correct, sequentially updated cache line will be provided. As can be seen above, the performance impact of this policy is negligible and the e-PDEMI architecture is able to maintain the average energy reduction of approximately 16.4% per core as discussed below.

When load instructions are reexecuted at retirement, the data retrieved from the L2 Filter Cache is compared against the data the load speculatively consumed. If the data matches, the filter cache signals the re-order buffer that the load may retire, and if the data does not match, it signals a flash clear of the VPC filter, and signals the re-order buffer that a replay from the instruction immediately proceeding the load must be triggered. Because the load receives the correct data from the L2 filter cache, it does not require replay. This is in contrast to Load Store Queue implementations where the load itself would need to be replayed. As a result, the architecture in the current invention can guarantee forward progress. As such, the StoreSet mechanism is not needed, and is therefore removed.

In the place of StoreSet predictors, a counter is implemented that can enforce periods of memory instruction serialization when replays begin to erode forward progress. Note, in benchmarks such as bzip2 there are replay interactions, particularly in loops, where a replay due to a particular load-store pair can trigger the replay of a nearby load store pair, and although forward progress is guaranteed, it becomes very slow. To quickly combat this problem, if the current invention detects forward progress below a threshold (less than 200 instructions between replays), all memory instructions are serially executed to the VPC for a set number of instructions. These modifications allow architects to scale up the surrounding structures (Instruction Window, Load and Store Units, re-order buffer etc.) to extract increased instruction level parallelism by supporting more in-flight memory instructions without complex scaling challenges, but the focus of this embodiment is to sustain performance equivalent to the baseline architecture with lower energy per instruction while removing the complexity of coherence and supporting the simplicity of a sequential consistency memory model.

Because store instructions are committed in-order and the VPC cannot displace speculative data to lower levels of the memory hierarchy, the e-PDEMI architecture does not pollute lower cache levels. As a result, replays remain decoupled from the memory hierarchy and do not require keeping checkpoints, or additional state based storage in order to repair the memory state. Avoiding memory pollution saves the dynamic energy associated with accessing the memory hierarchy for cache line displacements as well as the more costly multiple writes required to restore cache state during a replay.

Because access to the main memory hierarchy is off the critical path, the e-PDEMI architecture is able to tolerate longer memory latencies. As a result, from FIG. 2b it can be seen that the e-PDEMI memory hierarchy is composed of a set of private TLBs accessed by each e-PDEMI core, which will access a single shared banked L2 Filter Cache, which can access a larger banked L2 cache before the last level shared L3 cache. Since there are no private data caches in the multi-core e-PDEMI system, any given cache line will only reside in each structure in one location. As a result, data on the e-PDEMI system cannot become incoherent even in a multiple-reader/multiple-writer scenario. A coherence protocol, coherence support structures, and coherence interconnect are therefore not included in the multi-core e-PDEMI architecture. Finally, because of the multi-core e-PDEMI shared cache hierarchy and the in-order commit of stores from e-PDEMI cores discussed above, stores become globally visible in program order. Therefore, the multi-core e-PDEMI architecture also provides a sequential consistency memory model.

As described above, the e-PDEMI architecture supports sequential consistency. At verification, the ROB issues instructions in program order to the memory hierarchy for verification. In every cycle, a memory operation can go to one of the address mapped L2 Filter cache banks, each of which is non-blocking and has a Miss Status Handling Register (MSHR). If a store misses, it will pin down the corresponding cache line in the MSHR. Subsequent loads to the same address will also get pinned down in the same bank's MSHR, until the original store miss request is serviced. Once the store miss is resolved, all outstanding requests for that line are fulfilled in the order in which they were received by the L2 Filter cache bank.

In order to support increased memory instruction retirement throughput, a 2 phase commit protocol similar to the 2 phase commit protocol used in databases is provided. Each cycle, the ROB can send a memory verification request, if the request misses in the corresponding cache bank, it is held in the bank's MSHR like any other request until the earliest outstanding miss to the required cache line is serviced. Once a memory request is either a hit, or has its miss resolved, the MSHR sends a commit signal to the ROB which will then retire outstanding memory instructions in program order. Since the MSHR services all outstanding memory requests to the same line in the order in which they were received, and because memory verification requests are sent by the ROB in program order, the MSHR implicitly maintains the global visibility of stores in program order meeting the definition of sequential consistency. Unlike traditional caches, the VPC in the e-PDEMI architecture of the current invention does not suffer from classic problems implied by virtual indexing and virtual tag checking Due to its function as a predictor cache, the VPC is not required to handle virtual synonyms correctly. Consider the following example: A single process is running on the e-PDEMI architecture and obtains two virtual addresses that map to a single physical address. At an early point in time, the process modifies the contents pointed to by the first virtual address in the VPC. Some time later, the process modifies the second virtual address in the VPC. Finally, the process attempts to read from the first virtual address and receives the original data from the first virtual address in the VPC, however that data is now stale and not correct. Since each of the stores performed by the process would have updated the virtually indexed and physically checked L2 Filter cache at retirement in-order, when the load retires in the e-PDEMI system it would check the data it consumed against the data in the virtually checked and physically indexed L2 Filter cache (where there are no virtual synonyms) and would find that it consumed the wrong data. The correct data received from the L2 Filter cache would be committed to the architectural state of the system and a replay would be triggered from the next instruction guaranteeing correct forward progress. Another challenge that the e-PDEMI system could face due to virtually indexing and checking the VPC, is process address space violations due to context switching. For example, if an e-PDEMI system were running a process known to store a password in virtual address 100, a malicious process could attempt to access virtual address 100 in a running loop hoping to acquire the first process's password. The malicious process could then attempt a brute force attack by continually accessing virtual address 100 and attempting to use the data loaded as the password. If the password were accepted, the malicious process would branch. In the e-PDEMI system, for each time the malicious process attempts this load, it would fail verification at retirement, because the address would be translated to a physical address for the L2 Filter cache, which would yield a value from the malicious process's address space instead of the first process's address space. The malicious process could however read the branch predictor performance counter in the e-PDEMI system, and if it found that the last branch had been taken, then it would know the correct password had been found. In applications where such a security challenge were present, it is recommended that the OS perform a flash clear of only the VPC Filter and main VPC on context switches.

An example experimental set up is provided where a simulation setup is used that is similar to TASS. It modifies SESC, and uses QEMU as the functional emulator executing ARM instructions. It uses a modified version of McPAT for power estimation. Table 1 lists the parameters used to simulate each core of the baseline architecture, and Table 2 lists the parameters used to simulate each core of the proposed architecture. Both single-core and multi-core versions of the baseline and e-PDEMI architectures are simulated.

TABLE 1
Baseline per-core architectural parameters
Baseline Architecture

| | |
|---|---|
| Issue Width | 4 Instructions |
| Re-order Buffer | 256 Instructions |
| Load Queue | 48 Loads |
| Store Queue | 32 Stores |
| Branch Predictor | OGEHL |
| BTB | 4K entries-4-way |
| Integer ALUs | 4 units |
| Floating Point ALUs | 4 units |
| L1 TLB | 64 entries/Fully Assoc./1 cycle |
| L1 Data Cache | 1.6 KB/4-way/4 cycles |
| L2 Cache | 512 KB/16-way/7 cycles |
| L3 Cache | 8 MB/32-way/14 cycles |

TABLE 2
Proposed e-PDEMI per-core architectural parameters
e-PDEMI Architecture

| | |
|---|---|
| Issue Width | 4 Instructions |
| Re-order Buffer | 256 Instructions |
| Branch Predictor | OGEHL |
| BTB | 4K entries-4-way |
| Integer ALUs | 4 units |
| Floating Point ALUs | 4 units |
| L1 TLB | 64 entries/Fully Assoc./1 cycle |
| VPC Cache | 16 KB/4-way/4 cycles |
| VPC Buffer | 64 entries |
| Mem Spec Buffer | 48 Load entries, 32 Store entries |
| Filter Cache | 4 KB/16-way/single-core 2 cycles |
| | multi-core(banked) 6 cycles |
| L2 Cache | 512 KB/16-way/7 cycles |
| L3 Cache | 8 MB/32-way/14 cycles |

TABLE 3
Simulated SPEC2006 Benchmarks

| Type | Benchmark |
|---|---|
| Integer | hmmer, astar, h264ref, sjeng |
| | libquantum, omnetpp, gcc, bzip2 |
| Float | soplex, milc3, leslie3d, namd |
| | povray, bwaves, lbm, dealII |

TABLE 4
Simulated PARSEC and SPLASH Benchmarks

| Suite | Benchmark |
|---|---|
| PARSEC | blackscholes, bodytrack, canneal, x264 |
| (simlarge input set) | fluidanimate, swaptions, facesim |
| SPLASH | fft, fmm, ocean, radix |

The single-core versions were evaluated by running approximately 5 billion instructions from 16 SPEC2006 benchmarks. The multi-core versions were evaluated by running the PARSEC and SPLASH benchmarks to completion. All simulated benchmarks are shown in Table 4 to completion.

Below the evaluation of the architecture according to the current invention is presented. Studied are Performance, Energy efficiency and the area usage of e-PDEMI with respect to the baseline architecture.

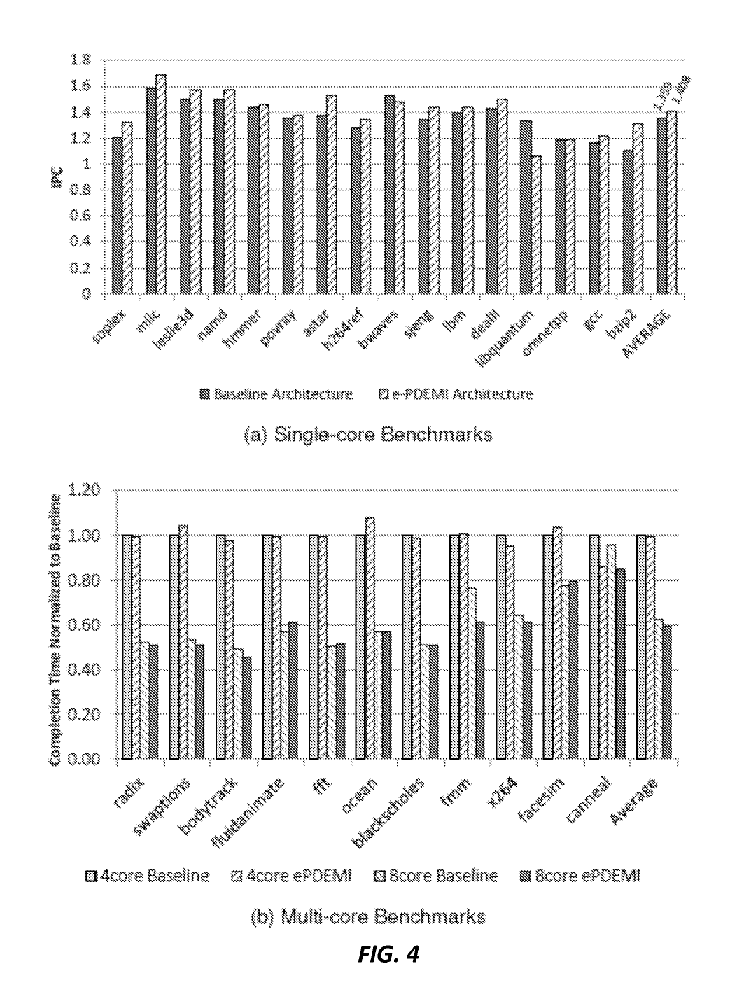

FIG. 4a shows the performance of the Baseline and e-PDEMI architectures in terms of uIPC, where uIPC is the retiring rate of micro-operations (result of instruction crack). As shown in FIG. 4a, the e-PDEMI architecture performs at similar levels to the Baseline architecture and in some cases can provide a speedup of up to 6%. Because the e-PDEMI architecture does not rely on a Load Store Queue for memory disambiguation, it does not experience the related stalls that come with those structures.

FIG. 4b shows the performance of the multi-core Baseline and e-PDEMI architectures in terms of benchmark completion times. The completion times are presented instead of IPC as it is noted that in multi-core workloads, IPC can be a misleading performance metric due to lock, barrier and other multi thread related instructions. Looking at FIG. 4b, the e-PDEMI architecture performs equivalently to the Baseline architecture, with a worst-case slowdown in ocean of 8%. In some cases greater speed ups can be achieved, the greatest of which is canneal at 14%, where canneal benefits from e-PDEMI's efficient handling of memory ordering instructions (membarrier, memfence, etc.). In the Baseline architecture, when a memory barrier, or memory fence instruction is encountered, the pipeline must be stalled so that the ROB can be drained and all previously in-flight instructions must be retired, before execution can continue. This mechanism is needed to guarantee that all store instructions prior to the memory barrier or fence are globally visible to all instructions executing after the memory barrier or fence.

In the e-PDEMI architecture, when a memory barrier or memory fence instruction is encountered, e-PDEMI is not required to stall the pipeline to drain the ROB. The in-order commit of memory instructions to a shared instead of private memory hierarchy guarantees that each Store instruction will be globally visible to any proceeding Load instruction at any point in time. This is the same mechanism that provides sequential consistency on the e-PDEMI architecture.

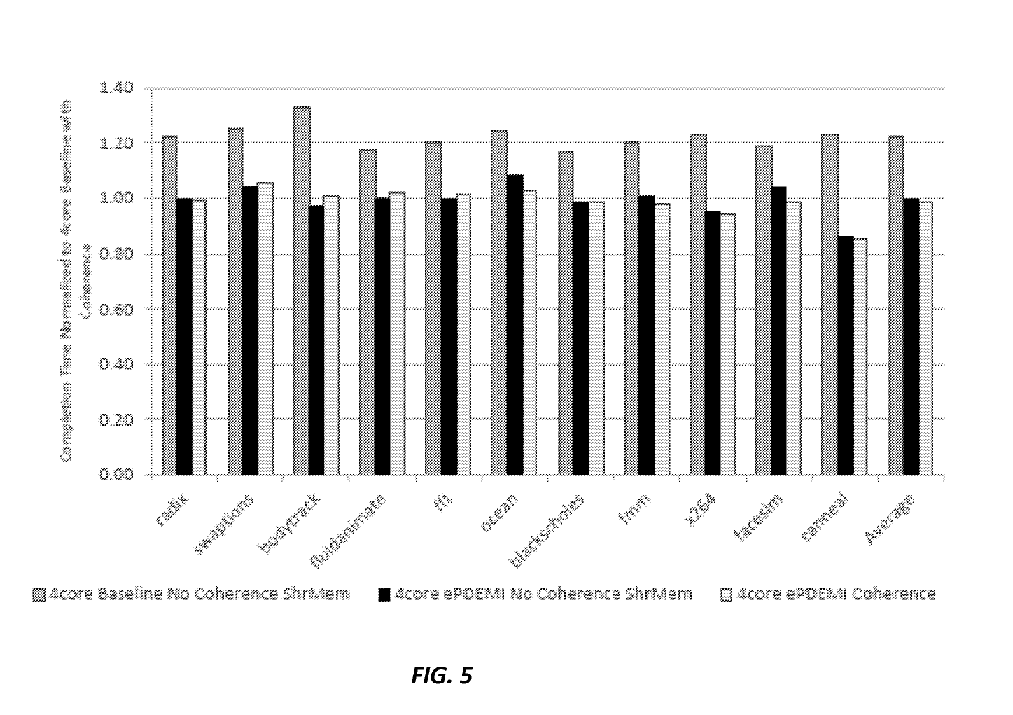

FIG. 5 shows that the Baseline architecture performance is particularly sensitive to the memory hierarchy configuration. FIG. 5 explores the performance impact of having a shared memory hierarchy with no invalidation-based coherence as in the proposed e-PDEMI architecture, and having a private memory hierarchy with invalidation-based coherence as in the Baseline architecture, on both architectures. It is seen that e-PDEMI appears mostly insensitive to this configuration choice, but the Baseline architecture performance suffers by over 20% without a private cache hierarchy with invalidation-based coherence. This is because e-PDEMI's memory hierarchy accesses are off the critical path and therefore not sensitive to the additional contention latency inherent in a shared memory hierarchy. However, all of the Baseline architecture's memory hierarchy accesses are on the execution critical path and thus the additional latency of a shared memory hierarchy is not well tolerated.

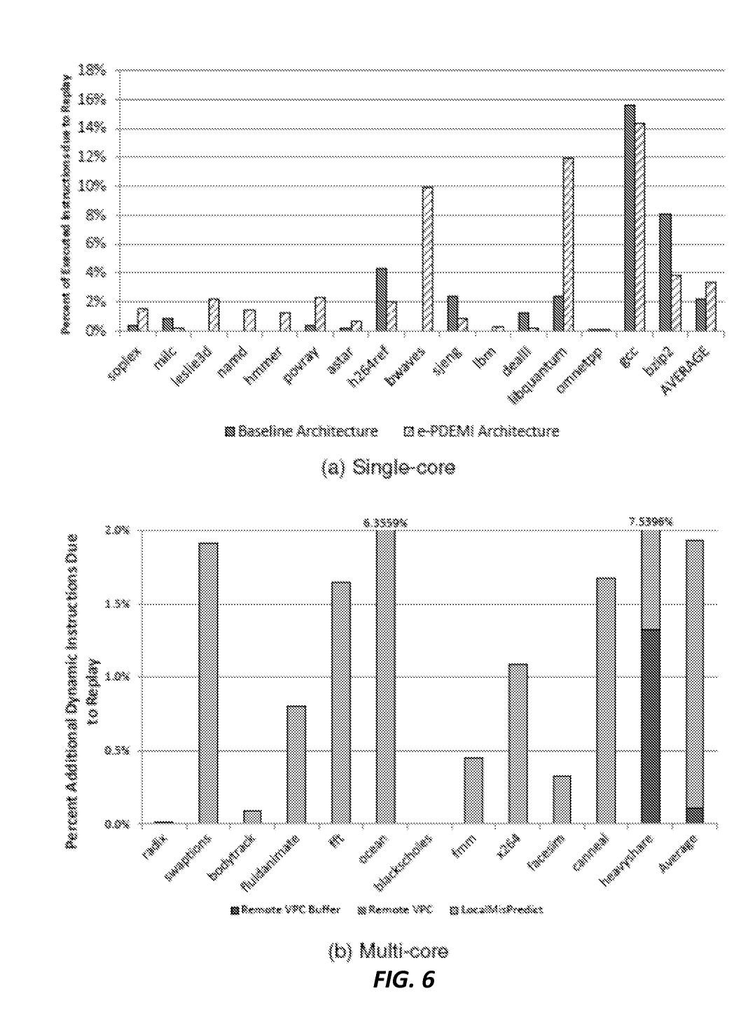

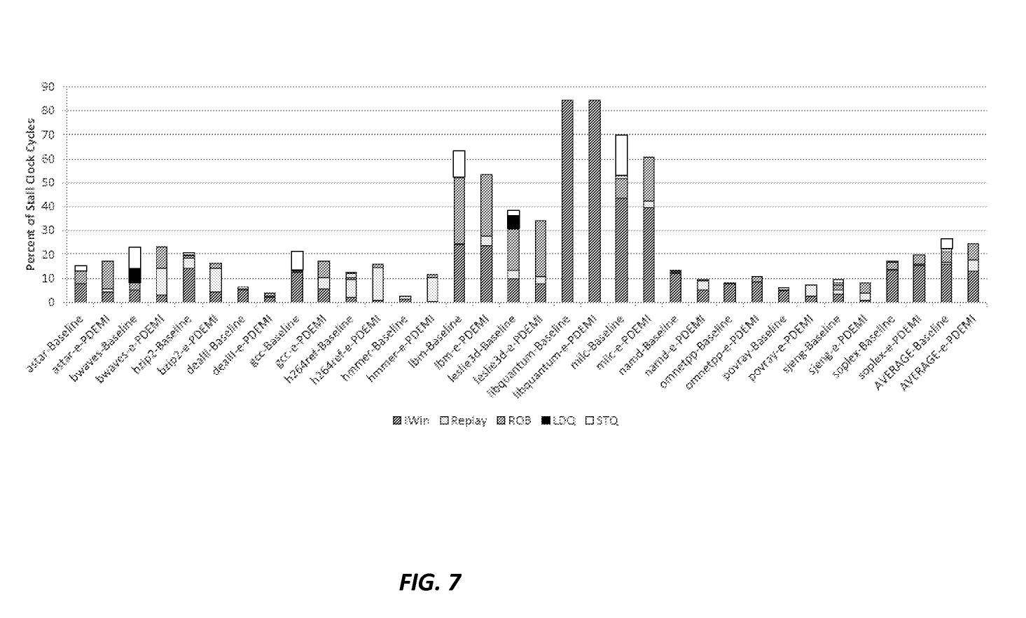

While the e-PDEMI architecture does increase replays, the proportion of instructions that are actually replayed is small on average, as shown in FIG. 6a and FIG. 6b. In the single core case the s jeng benchmark is a good example of increased replays that do not necessarily slow performance. The e-PDEMI architecture achieves a speed up of 4.5% for s jeng although there is an increase of 4% more instructions replayed. The reason for this can be seen in FIG. 7, by looking at the pipeline stalls due to the instruction window. 3.5% of the execution time on the baseline system is spent on stalls generated by the instruction window. In contrast, the e-PDEMI architecture system only spends 0.8% of the execution time on stalls generated by the instruction window.

The additional instruction window stalls in the baseline system are due to StoreSets' serialization. Although the baseline has far fewer instructions replayed than the e-PDEMI architecture, it achieves that low replay frequency by over-serializing memory instructions that may have triggered replays in the past, but were safe to execute out-of-order going forward. Because the e-PDEMI architecture uses a serialization technique, it only serializes instructions during periods of low forward progress (less than 200 instructions between replays) and thus will return to speculatively executing memory instructions out-of-order after a fixed period of time. The impact of lessening the instruction window pressure in the e-PDEMI architecture can provide more opportunity for the processor to extract increased ILP and thus mitigate the effects of increased replays.

Because the e-PDEMI architecture does not use StoreSets, it is more likely to trigger replays (due to misprediction) than the Baseline architecture. The e-PDEMI architecture increases the fraction of instructions replayed on average by 3.33% in the single-core implementation and 1.9% in the multi-core implementation. As shown in FIG. 7, this increase in replays is mitigated by the e-PDEMI architecture experiencing slightly fewer stalls on average than the Baseline architecture. The e-PDEMI architecture experiences slightly fewer stalls because it does not experience Load Store Queue stalls, does not use StoreSets, and stops fetching new instructions in the event of a replay.

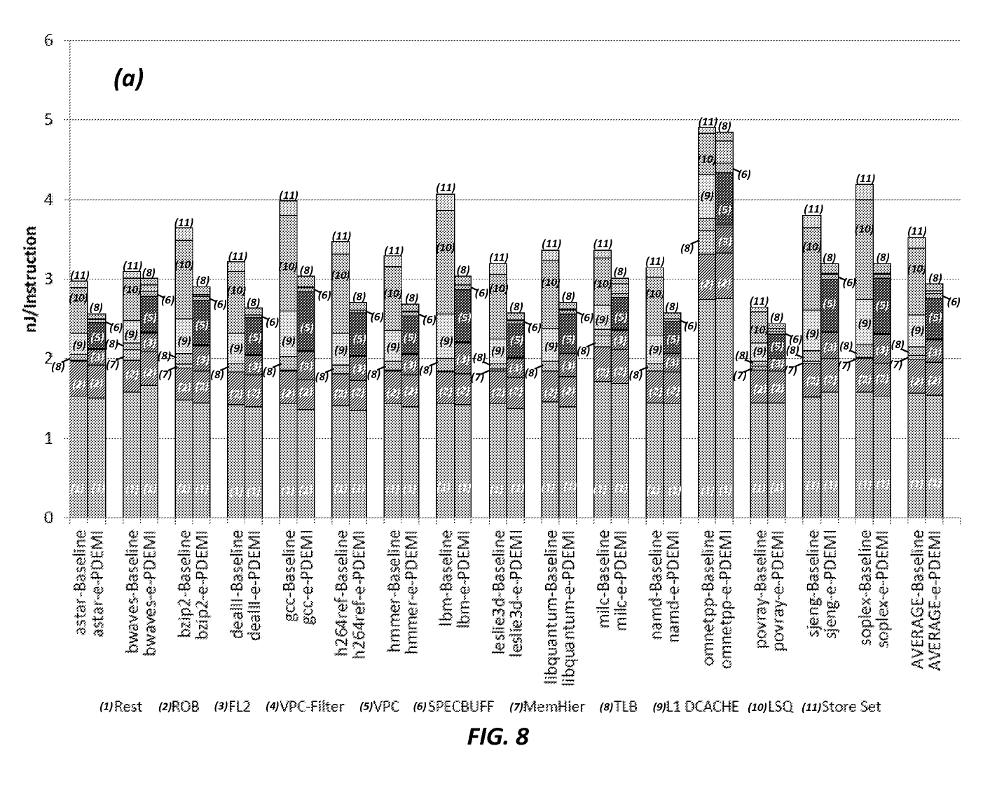

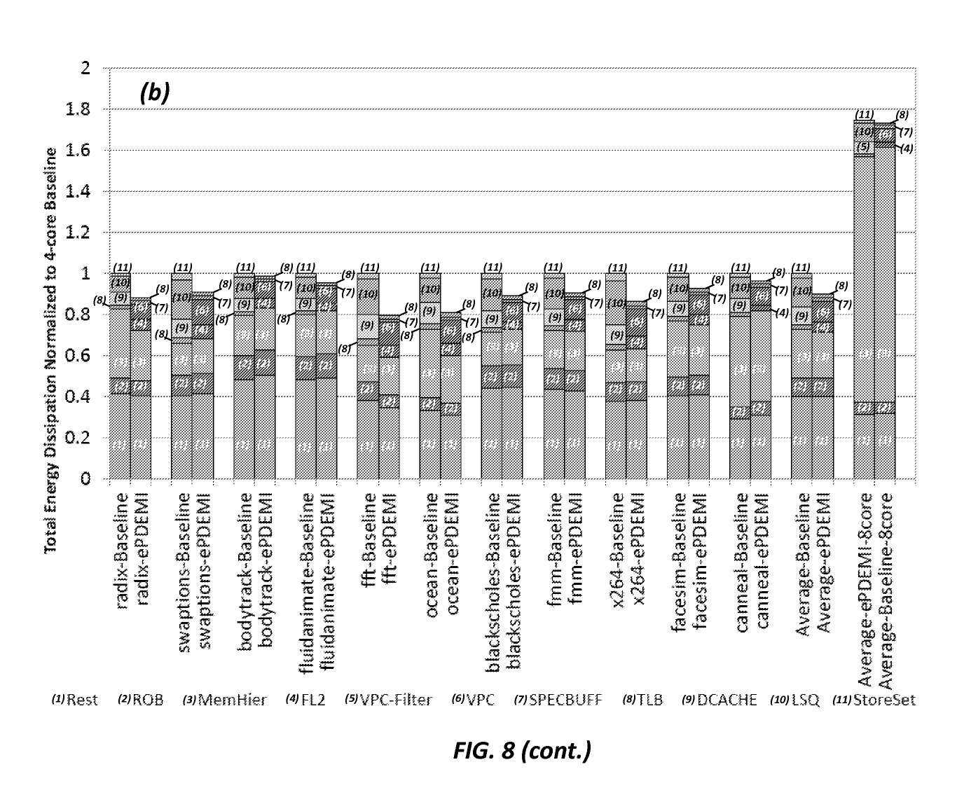

It is also important to note that as seen in FIG. 8, the e-PDEMI architecture is able to recover any additional energy per instruction dissipation it experiences due to increased replays by saving the additional energy per instruction associated with the Load Store Queue and StoreSets. Finally, FIG. 4a and FIG. 4b show that additional replays in the VPC architecture do not significantly impact its performance. The bwaves benchmark demonstrates this behavior. Looking at FIG. 8, we see that on the e-PDEMI architecture, re-order buffer power is increased while running bwaves due to the additional replays it generates on the e-PDEMI architecture as seen in FIG. 6a. The “Rest” category experiences a 6% increase in energy per instruction as well. However, the energy savings that the e-PDEMI architecture achieves due to the absence of the Load Store Queue and the StoreSets, offsets these increases and thus the e-PDEMI architecture is still able to save energy.

FIG. 6b corresponds with FIG. 6a showing that in the multi-core case e-PDEMI does not create significantly more dynamic instructions due to replay. On the multicore e-PDEMI architecture, there are three possible causes of replay. The first and most prevalent is the same as on the single-core e-PDEMI implementation, where local mispredictions in the VPC Buffer or VPC cause a load to consume incorrect speculative data. The other two replay types can occur due to the timing of remote data sharing. If a load on core 0 needs to consume the data stored by a store on core 1, because there is no communication or coherence between cores' VPCs, the load will only be able to consume the data once the Store has retired and committed its data to the shared memory hierarchy. The data the load requires at execution time could be in a remote VPC Buffer or VPC. Additionally, it is possible that the load could consume stale data from its own VPC that was written by a previous local store. These cases were specifically tracked and found them to be rare. In order to be sure there was no malfunction or oversight in our simulations, a micro-benchmark was created (shown as “heavyshare” in FIG. 6b) to attempt to force this behavior by having threads simply increment the same counter in tight loop, requiring each thread to read the value of the counter and then write a new value. It was found that when executing this benchmark, replays due to data being present in a remote VPC Buffer or VPC account for 17.5% of total replays for a 4 threaded simulation as shown in FIG. 6b, and up to 23% of total replays for an 8 threaded simulation. For the rest of the simulated PARSEC benchmarks, it is seen that although local replays increase moderately, remote triggered replays do not become a substantial contributor. Because e-PDEMI supports sequential consistency and uses a shared memory hierarchy across cores, store data becomes globally visible in program order. As such, either a load will hit in its local VPC (either consuming the correct data or triggering a replay), or a load will miss in its local VPC and the data it consumes from the memory hierarchy will be sequentially updated data.

FIG. 7 shows the fraction of execution time spent on system stalls occurring from various functional units. Branch misprediction stalls are not shown in FIG. 7 for simplicity since they are out of the scope of this paper and are not affected by the e-PDEMI architecture with respect to the Baseline architecture. The remainder of the execution time is spent in active operation. It is seen that the e-PDEMI architecture reduces Instruction Window pressure in most cases. This is partially because both the Baseline and the e-PDEMI architectures stop fetching instructions during a replay, and since the e-PDEMI architecture uses commit time verification, it puts more pressure on the Re-order buffer rather than the Instruction Window in the average case. The e-PDEMI architecture clearly has more stalls due to replays, but on average it has slightly less stalls in total as seen in the plot, due to avoiding Load Store Queue stalls.

Some applications like milc experience a small slow down on the e-PDEMI architecture due to increased re-order buffer stalls related to in-order commit. The e-PDEMI architecture reduces total stalls during the execution of dealII with respect to the baseline architecture by almost 50%. By saving all store queue stalls and some instruction window stalls, the e-PDEMI architecture is able to tolerate increases in re-order buffer and replay stalls.

One method of potentially improving the baseline architecture's performance would be to increase the instruction window size. However, increasing the Instruction Window size is very costly because it would have to be significantly increased and Instruction Windows are typically implemented using fully associative CAMs which would consume substantially more power. The e-PDEMI architecture in the average case nearly doubles re-order buffer stalls, but because it does not experience Load Store Queue related stalls, overall stalls are reduced. While in most cases where the e-PDEMI architecture saves Load Store Queue stalls, it gains them back in replays, however as shown in FIG. 4a and FIG. 4b, the e-PDEMI architecture is able to perform equivalently to the Baseline architecture and save energy.

FIG. 8a illustrates the energy per instruction for each simulated single-core benchmark and total energy consumption for each multicore benchmark running on both the baseline architecture and proposed e-PDEMI architecture as described above. The most important insight FIG. 8a and FIG. 8b provide is that the e-PDEMI architecture reduces energy per instruction for total energy across all benchmarks. The average energy per instruction reduction is 16.4% in the single core case, and 10% in the multicore case. The “Rest” of the core consumption about the same energy per instruction in both the Baseline and e-PDEMI systems due to the stall trading shown in FIG. 7. It is noted that this trend continues in the multicore case. This may seem counter intuitive because memory instructions must be verified and e-PDEMI increases the amount of replayed instructions. Verification does not impact register file nor re-order buffer energy consumption per instruction with respect to the baseline. The register file energy consumption is not increased because instruction verification does not access the register file. e-PDEMI stores load and store instructions' out-of-order execution information in the memory speculation buffer (shown in FIG. 8 as “SPECBUFF”). Due to its relatively small size, the memory speculation buffer does not significantly increase the energy per instruction on the e-PDEMI architecture. The re-order buffer energy or other structures such as the rename logic does not increase, because only a small percentage of instructions need to be replayed as shown in FIG. 6a and FIG. 6b and the amortized cost is negligible.

The energy per instruction savings the e-PDEMI architecture achieves is maintained by carefully re-balancing other memory hierarchy structures to avoid increasing the energy consumption per instruction. Since the memory hierarchy is off the critical path, the e-PDEMI architecture can tolerate longer latencies while maintaining equivalent performance. The addition of a small L2 Filter cache avoids the potentially costly L2 verification access.

The baseline architecture is also simulated with an L2 Filter cache and it was found that there was no appreciable performance impact, but a small increase in energy consumption. Therefore an L2 Filter cache is not included in the Baseline architecture. In the e-PDEMI architecture, many of the L2 Filter accesses are memory verification requests, which are off the critical path. Therefore, e-PDEMI is able to tolerate the additional potential latency associated with adding a new structure into the memory hierarchy. The VPC Buffer and VPC collectively have a high hit rate, which although does not guarantee that correct data is consumed by load instructions, does prevent accesses to the Filter L2 cache. In a multicore implementation, the Baseline architecture is required to maintain coherence between private L2 Filter caches whereas, because e-PDEMI uses a multi-banked shared L2 Filter cache, no coherence accesses are required. The drawback to making each structure in the memory hierarchy a multi-banked shared structure across the e-PDEMI cores is that the total leakage energy is increased, which accounts for the larger proportion of “MemHier” energy consumption shown in FIG. 8b.

Neither the baseline nor e-PDEMI architectures experience any significant energy per instruction in the L2 or L3 caches (labeled “MemHier”) in the single core case.

The VPC is more energy efficient than the L1 cache even with the same size and organization. The VPC implements several optimizations only possible in a speculative cache. Specifically, the VPC includes a small filter to simultaneously minimize speculative data pollution of the VPC, and to reduce the VPC's energy consumption per instruction. The VPC buffer is able to service a significant amount of memory accesses (over 20%), that would otherwise issue to the VPC and thus increase its activity rate. Additional small energy savings are due to the fact that the VPC does not allocate cache lines on write misses and it never performs write backs to the next level of the memory hierarchy.

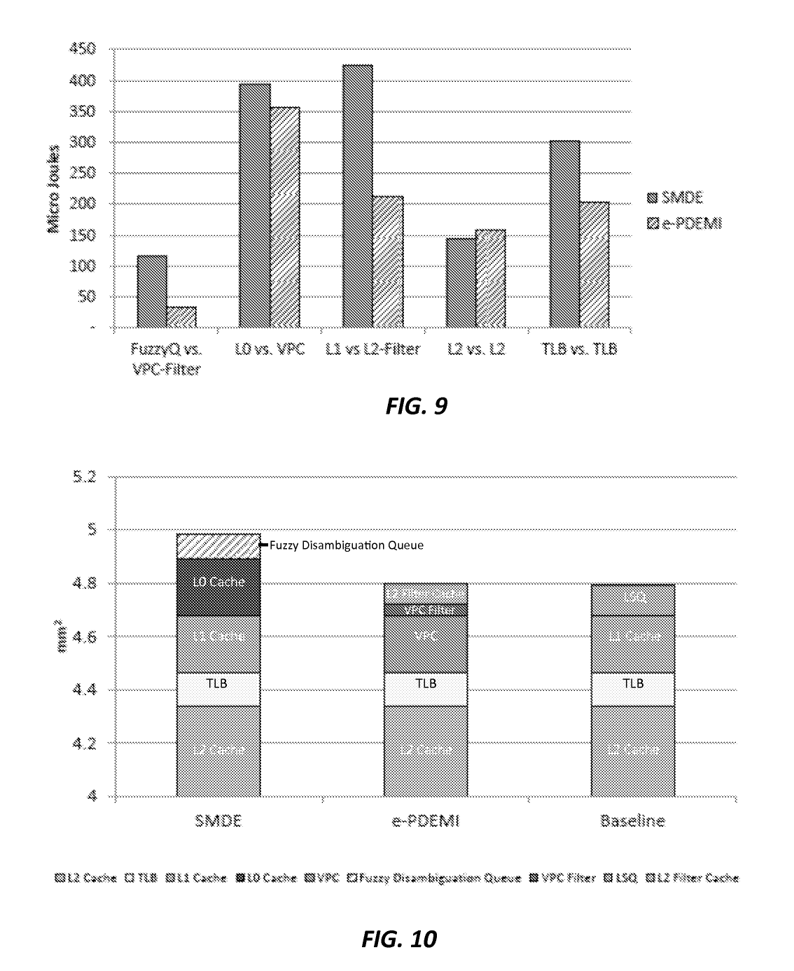

In FIG. 9, compare are the average energy consumed by the memory hierarchy for the single-core e-PDEMI architecture and the single-core memory hierarchy in the SMDE architecture. For fairness of comparison, each of the memory structures in the SMDE are sized to be the same as their counterparts in e-PDEMI. A CACTI 5.3 is used to estimate the energy per access for each structure. Table 5 shows the structures from both SMDE and e-PDEMI and their selected sizes. To compute average energy consumption over the set of the benchmarks evaluated, the average activity rates for each memory structure were used and multiplied by the energy per access as estimated by CACTI. In FIG. 9, it is seen that the SMDE TLB consumes substantially more energy than the e-PDEMI TLB. The SMDE L0 cache does not consider virtually checked cache. Therefore the additional TLB energy consumption is due to the need for the TLB to support virtual address based accesses to the L0 and L1 caches. Because of this requirement, the SMDE TLB has a significantly increased energy consumption per access with respect to the e-PDEMI TLB which is off the critical path. It is also seen that because the VPC Buffer is a direct mapped structure compared to the fully associative Fuzzy Disambiguation Queue used in SMDE, it consumes less energy on average. Comparing the VPC with the L0 cache, it is seen that the VPC consumes slightly less energy than the L0 cache on average. This effect is due to the filtering mechanism of the VPC Buffer. The VPC Buffer prevents some accesses to the VPC, which lowers the VPC's activity rate and thus its average energy consumption. The most significant difference between e-PDEMI and SMDE in terms of energy consumption comes from e-PDEMI's L2 Filter Cache. The SMDE L1 cache has the same activity rate as the L2 Filter Cache, but the L2 Filter Cache consumes almost 50% less energy per access than the L1 cache in SMDE because it is much smaller. Finally, e-PDEMI's L2 cache consumes slightly more energy on average than SMDE's L2 cache due to a slightly increased activity rate. This effect is attributed to the smaller L2 Filter cache, which has a higher miss rate than the much larger L1 cache in SMDE. However, the average energy consumption found in the VPC and L2 Filter are enough to overcome this additional energy consumption, leading to an overall average energy consumption savings in the e-PDEMI memory hierarchy of almost 44% with respect to the SMDE memory hierarchy.

TABLE 5
e-PDEMI and SMDE Memory Hierarchies

| e-PDEMI | SMDE |
|---|---|
| VPC Buffer | Fuzzy Disambiguation Queue |
| 64 entry, direct mapped | 16 entry fully associative |
| TLB | TLB |
| 64 entry 4-way | 64 entry fully associative |
| VPC | L0 Cache |
| 16 KB 4-way | 16 KB 4-way |
| L2 Filter Cache | L1 Cache |
| 4 KB 16-way | 16 KB 4-way |
| L2 Cache | L2 Cache |
| 512 KB 16-way | 512 KB 16-way |

Using CACTI, the area required for the SMDE, e-PDEMI and Baseline memory hierarchies are estimated. Because only the memory hierarchies differ between e-PDEMI and the Baseline architecture, and the same architectural parameters were assumed for SMDE, only considered were each architecture's memory hierarchy area cost shown in FIG. 10. The VPC and VPC Buffer combine to make up 22% less area than the L1 and LSQ combined from the Baseline architecture. Since the VPC and L1 cache are the same size, this area savings is attributable to the large size of the fully associative LSQ with respect to the smaller VPC filter. Having both an L0 and L1 cache that are the same size causes SMDE to be much bigger in area than either e-PDEMI or the Baseline architecture. e-PDEMI's major area savings over the SMDE architecture is the replacement of the full size L1 cache with the 62% smaller L2 Filter cache. Additionally, the fully associative Fuzzy Disambiguation Queue requires almost 53% more area than the VPC filter. e-PDEMI uses approximately the same area as the Baseline architecture.

Presented above is a novel energy efficient memory hierarchy that performs equivalently to state of the art processors while significantly reducing total energy consumption, and supporting Sequential Memory Consistency; called e-PDEMI. e-PDEMI includes a Virtual Predictive Cache and filter caches with low complexity. The Load Store Queue and Store Sets sets are removed in favor of a decoupled memory speculation mechanism with in-order commit and verification. e-PDEMI reduces overall processor power by 16.4% on average with no average performance impact and up to 14% in multi-core applications with frequent memory fences or barriers.

In-order verification, novel two phase commit, and an address mapped cache hierarchy makes stores appear globally in program order, supporting Sequential Memory Consistency.

The e-PDEMI architecture provides equivalent performance to a traditional out-of-order processor and saves power. It simplifies out-of-order processors' memory sub-system implementation and provides straight forward memory disambiguation.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. A decoupled memory execution verification method, comprising executing load and store commands separately using an appropriately programmed computer, wherein said load and store commands are independent of correctness, wherein said load commands and said store commands are re-executed in-order at memory retirement to verify correctness, wherein an energy efficient power decoupled execution of memory (e-PDEMI) is provided.

2. The decoupled memory execution verification method of claim 1, wherein memory operations are decoupled into critical and non-critical operations, wherein said critical operations comprise a relatively low memory latency, wherein said critical operation does not have a correctness requirement, wherein said non-critical requirement comprises a relatively high memory latency, wherein said non-critical operation has a correctness requirement.

3. The decoupled memory execution verification method of claim 1, wherein a virtual predictive cache (VPC) replaces an L1 data cache and a L0 data cache, wherein said VPC comprises a virtually indexed and virtually checked cache structure.

4. The decoupled memory execution verification method of claim 3, wherein said VPC guarantees forward progress of any incorrect memory content, wherein said guaranteed correct memory contents are received at said memory retirement, wherein said memory retirement is disposed in an insensitive portion of a critical memory path, wherein a shared address mapped cache hierarchy is provided.

5. The decoupled memory execution verification method of claim 1, wherein each said e-PDEMI comprise an e-PDEMI core, wherein said e-PDEMI core provides a sequential consistency memory model in a multi-core configuration.

6. The decoupled memory execution verification method of claim 1, wherein said in-order verification eliminates memory ordering instructions, removes a coherence network from a memory hierarchy, eliminates store sets, and removes load store queues.

7. The decoupled memory execution verification method of claim 1, wherein all speculative data are stored in a direct mapped memory buffer, wherein memory replays are mitigated using a serialization mechanism, wherein a sequential consistency is implemented without a requirement of rolling back a cache hierarchy state.

8. The decoupled memory execution verification method of claim 1, wherein said store instructions comprise an in-order memory issuance, an out-of-order address calculation, a write to a Value Prediction Cache (VPC), an in-order memory retirement in a re-order buffer (ROB), in-order writing of data to an L2 filter, and updating said VPC.
